(19) United States
(12) Patent Application Publication
(10) Pub. No.: US 2013/0124563 A1
(43) Pub. Date: May 16, 2013

(54) CONTROLLING PRE-FETCHING OF MAP DATA TILES BASED ON SELECTABLE PARAMETERS

(71) Applicants: Hans-Olav CaveLie, San Francisco, CA (US); Thomas G. Nourse, Half Moon Bay, CA (US)

(72) Inventors: Hans-Olav CaveLie, San Francisco, CA (US); Thomas G. Nourse, Half Moon Bay, CA (US)

(73) Assignee: GOOGLE INC., Mountain Vew, CA (US)

(21) Appl. No.: 13/297,363

(22) Filed: Nov. 16, 2011

(51) Int. Cl. G06F 17/30

(52) U.S. Cl. 707/770; 707/E17.032; 707/E17.044

(57) ABSTRACT

A system and method identifies pre-fetch map data to be downloaded from a remote server, having a map database, to a client device by using selectable parameters to control pre-fetching. For example, device specific parameters, such as device model number, and user specific parameters, such as user interests, may be accessed by the system and method and analyzed to determine which pre-fetch map data should be downloaded from the remote server. These parameters may be automatically stored on the client device or may be manually entered by the user. The responsive pre-fetch map data may be identified by map data type, map points of interest, map zoom level, or some other manner. Where the map database stores map data in tiles, the remote server will send selected map data tiles to the client device as the pre-fetch map data.

### FIELD OF TECHNOLOGY

The present disclosure relates to map data optimization and more specifically to a system and a method to pre-fetch map data from a remote map database.

### BACKGROUND

With the widespread use of mobile devices, such as mobile phones, personal data assistants, tablet personal computers, etc., consumer demand for ready access to varied types of data continues to grow at a high rate. These devices are used to transmit, receive, and store text, voice, image, and video data. Consumers often look to store large numbers of applications on these devices, such that mobile devices are often touted more for the number of available applications, than internal processor speed. While consumers have come to desire fast access to data, the sheer amount of data required to run these applications places a premium on data management, both at the device level and at the network level. This premium limits the effectiveness of applications such as mapping applications, which typically require comparatively large amounts of network data.

Mapping applications are found in a variety of mobile devices, including car navigation systems, hand-held GPS units, mobile phones, and portable computers. These applications are among the most frequently used applications and are considered, by some, necessary for personal safety. Although the underlying digital maps are easy to use from a user's perspective, creating a digital map is a data intensive process. Every digital map begins with a set of raw data corresponding to millions of streets and intersections. That raw map data is derived from a variety of sources, each providing different amounts and types of information. To effectively map a location, locate a driving route between a source and a destination, identify points of interest, etc. requires substantial amounts of data. Furthermore, many mapping applications require display of different map data at different zoom levels, i.e., different scales, where the amount of detail and that nature of that detail changes at each zoom level. For example, at a lowest zoom level, scaled farthest away from a target, the map data may contain the boundaries of continents, oceans, and major landmasses. At subsequent zoom levels, that map data may identify countries, states, homelands, protectorates, and other major geographic regions. While at even further subsequent zoom levels, that map data may contain major roads, cities, towns, until eventually the map data contains minor roads, buildings, down to even sidewalks and walk ways depending on the region. The amount of detail is determined by the sources of information used to construct the map data at each zoom level. But no matter the zoom level, the amount of information is voluminous and generally too large for storage, in total, on mobile devices and too large for continuous download over a wireless communication network.

In operation, mapping applications typically download map data to the mobile device through a wireless communication network and in response to a user entering a location of interest and/or based on the current location of the mobile device, such as the current global positioning satellite (GPS) data or current cellular network location data for the device. A conventional technique for downloading map data is to have the mobile device communicate this location data to a remote processor on the wireless communication network, which, in response, downloads all map data to the mobile device or the map data requested for display to the user.

Generally speaking, the map data is stored in blocks known as map data tiles, where the number of map data tiles increases with zoom level. The remote processor provides a subset of the available map data tiles for a particular location or region to the mobile device for storage and display at any particular time via a map display application. By providing large numbers of map data tiles, the mobile device may buffer the map data for display to the consumer as the consumer scrolls across an area using the mapping application looking for adjacent or other mapping locations. However, the larger the number of map tiles provided at any particular time increases the download time and buffer memory usage while the user is using the map display application.

This conventional downloading of large amounts of map data tiles taxes network infrastructure and requires sizable memory allocation within the mobile device. As a result, there is a need to have more intelligent mechanisms for downloading map data, in particular map data tiles, to sufficiently satisfy the needs of the user, while doing so in a manner that addresses network bandwidth limitations and scarce memory availability.

### SUMMARY

In an embodiment, a computer-implemented method comprises: identifying, on a client device, one or more pre-fetch selection parameters, where the pre-fetch selection parameters include at least one of device parameters associated with the client device and user parameters; determining, on the client device, from the one or more identified pre-fetch selection parameters, a pre-fetch map data policy; requesting, from a remote map database storing the map data, pre-fetch map data stored in the remote map database and corresponding to the pre-fetch map data policy determined on the client device, wherein the pre-fetch map data is to be stored on the client device for eventual rendering of a visual display of map data in response to a subsequent user request; receiving, at the client device, the pre-fetch map data from the remote database and corresponding to the pre-fetch map data policy; and storing the received pre-fetch map data in a local memory on the client device until the subsequent user request

In another embodiment, a computer-readable medium storing instructions, the instructions when executed by a processor cause the processor to: identify one or more pre-fetch selection parameters, where the pre-fetch selection parameters include at least one of device parameters associated with the client device and user parameters; determine, from the one or more identified pre-fetch selection parameters, a pre-fetch map data policy; request, from a remote map database storing map data, pre-fetch map data stored in the remote map database and corresponding to the pre-fetch map data policy determined on the client device, wherein the pre-fetch map data is to be stored on the client device for eventual rendering of a visual display of map data in response to a subsequent user request; receive, at the client device, the pre-fetch map data from the remote database; and store the received pre-fetch map data in a local memory on the client device until the subsequent user request.

In yet another embodiment, a computer system for fetching map data to be used in rendering a visual display of map data on a client device, the computer system comprises: a display module for rendering the visual display of the map data on the client device; a pre-fetch selection module to analyze pre-fetch selection parameters for the client device to determine a pre-fetch map data policy for the client device, wherein the pre-fetch selection parameters include at least one of device parameters associated with the client device and user parameters; and a database interface module to request, from a remote server having a map database, pre-fetch map data responsive to the pre-fetch map data policy, and to receive, from the remote server, the pre-fetch map data responsive to the pre-fetch map data policy, wherein the pre-fetch map data is to be stored on the client device for eventual rendering of a visual display of map data in response to a subsequent user request.

In a further embodiment, a computer-implemented method for downloading pre-fetch map data to a client device for use in rendering a visual display of map data on the client device, the method comprises: receiving a pre-fetch map data policy request from the client device, where the pre-fetch map data policy request comprises one or more map data traits and wherein the pre-fetch map data policy request depends on device parameters or user parameters for the client device; analyzing the one or map data traits in the pre-fetch map data policy request to determine pre-fetch map data corresponding to the device parameters or the user parameters for the client device, wherein the pre-fetch map data is to be stored on the client device for eventual rendering of a visual display of map data in response to a subsequent user request; and transmitting the pre-fetch map data to the client device.

In a still further embodiment, a computer-readable medium storing instructions, the instructions when executed by a processor cause the processor to: receive a pre-fetch map data policy request from the client device, where the pre-fetch map data policy request comprises one or more map data traits and wherein the pre-fetch map data policy request depends on device parameters or user parameters for the client device; analyze the one or map data traits in the pre-fetch map data policy request to determine pre-fetch map data corresponding to the device parameters or the user parameters for the client device, wherein the pre-fetch map data is to be stored on the client device for eventual rendering of a visual display of map data in response to a subsequent user request; and transmit the pre-fetch map data to the client device.

In yet another embodiment, a server for downloading pre-fetch map data to a client device for use in rendering a visual display of map data on the client device, the server comprises: a memory for storing a map database; and a pre-fetch engine configured to, receive a pre-fetch map data policy request from the client device, where the pre-fetch map data policy request comprises one or more map data traits and wherein the pre-fetch map data policy request depends on device parameters or user parameters for the client device, analyze the one or map data traits in the pre-fetch map data policy request to identify from the map database pre-fetch map data corresponding to the device parameters or the user parameters for the client device, wherein the pre-fetch map data is to be stored on the client device for eventual rendering of the visual display of map data in response to a subsequent user request, and transmit the pre-fetch map data to the client device.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is high-level block diagram of a wireless network depicting a wireless base station connected to a server containing map data for selectively communicating that map data to a various client devices on the network.

FIG. 2 is a block diagram of an example map generator in the client device of FIG. 1.

FIG. 3 illustrates a portion of the data structure for the map database of FIG. 1.

FIGS. 4A, 4B, and 4C illustrate example renditions of map data at three different zoom levels, respectively.

FIG. 5 illustrates an example process or flow diagram for using selectable parameters to control pre-fetching of map data from a remote server.

FIGS. 6A, 6B, and 6C illustrate example renditions of the map data of FIGS. 4A, 4B, and 4C, at three different zoom levels, respectively, and showing points of interest at the different zoom levels.

FIG. 7 illustrates an example process or flow diagram for constructing and displaying pre-fetch map data visually.

FIG. 8 illustrates an example process or flow diagram for assembling a pre-fetch map data policy based on selectable parameters.

FIG. 9 illustrates an example process or flow diagram as may be performed in illustration of FIG. 8 to identify map data traits that will form the pre-fetch map data policy.

FIG. 10 illustrates an example process or flow diagram as may be performed on the remote server to identify pre-fetch map data and to communicate to a client device.

FIG. 11 illustrates an example pre-fetch map data policy request frame as may be communicated from the client device to the remote server in accordance with FIG. 10.

### DETAILED DESCRIPTION

The present application describes techniques for fetching map data over a selected subset of the entire map data available, by analyzing one or more pre-fetch selection parameters. The techniques, which may be implemented on a client device such as a mobile or handheld device, will determine which map data to pre-fetch from a remote database based on the selection parameters. In this way, the client device may be populated with a portion of all available map data, where that portion is selected based on the parameters associated with the client device. These parameters may be device parameters, i.e., associated with the hardware itself; while in the other examples, these parameters may be user parameters, i.e., dependent on the user of the client device. In some embodiments, the client device automatically determines which parameters are to be used in identifying pre-fetch map data, e.g., based on a set of predetermined conditions. In other embodiments, the particular parameters are manually determined, e.g., by input from the user.

In some embodiments, the map data is stored at the remote server in the form of map data “tiles.” In such examples, the techniques rely upon analysis of these pre-fetch selection parameters to identify map data tiles as the pre-fetch map data.

More particularly, the present application describes techniques for fetching map data over a selected subset of the entire map data available by using selection parameters for each client device. These selection parameters may include device parameters, such as static parameters such as a hardware platform type, a device model/version type, language setup, screen size, screen resolution, APIs available on the device and their versions and locale. Dynamic device parameters may be used such as a location of the client device, available memory, and network speed. In other embodiments, these selection parameters including user parameters, such as hobbies or items of interest, user usage patterns, user account type, number of bytes remaining in a user's (e.g., monthly) service data plan of if the user has requested to limit or ramp up the amount of caching on the device. In yet other embodiments, a combination of any of these or other suitable selection parameters may be used. Stored values for these selection parameters are examined—in some embodiments at the client device and it other examples at least partially at a remote server—from which a pre-fetch map data policy can be identified. The identified pre-fetch map data policy may be used to identify different types of pre-fetch map data. In some embodiments, the selection parameters are used to determine a pre-fetch map data policy that identifies map data tiles, map points of interest, and/or zoom levels.

When used to determine map points of interest and zoom level, the client device identifies that data to a remote server that contains a map database of the entire map data, including map data for the points of interest. With the points of interest identified, the remote server begins transmitting the map data, corresponding to these points of interest, to the client device for storage and display to the user. Storing map data in data blocks known as map data “tiles,” the remote server sends the map data in the form of a map data tiles. For each point of interest, the server may send an identified set of map data tiles, termed pre-fetch map data tiles.

Pre-fetching refers to requesting map data from a remote map database, such as that of a remote server, prior to any specific user request for map data, so that map data may be collected and buffered on a device until a specific user request for map data. In this way, pre-fetching seeks to collect map data in the background, before that map data is called upon to construct a visual display, thereby reducing (and even eliminating) the need for a client device to request map data only after a user request. The pre-fetched map data is automatically identified, requested, and stored on the client device for subsequent use in constructing a visual display. As discussed in examples below, where that map data is stored in the remote map database in the form of map data tiles, the pre-fetching is of map data tiles.

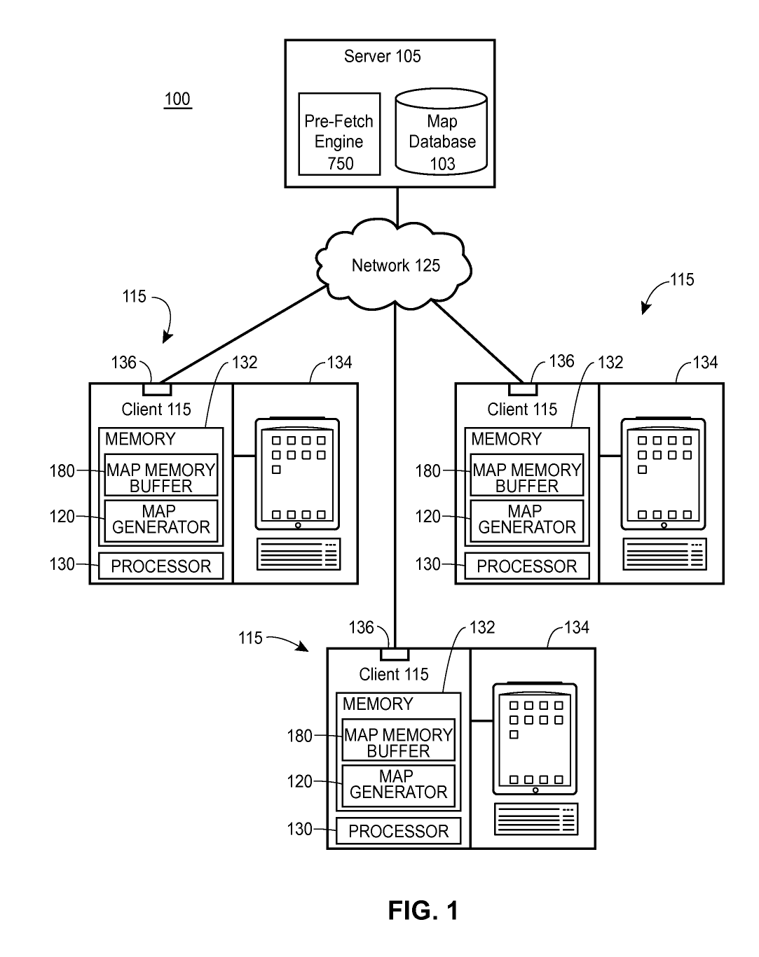

FIG. 1 is a high-level block diagram that illustrates a computing environment for a pre-fetch map data system 100 that may be used to access and store map data within a map database. As illustrated in FIG. 1, the computing environment includes a map database 103 connected to or disposed within a server 105, which is, in turn, connected to a number of client devices 115 through a network 125. The network 125 includes but is not limited to any combination of a LAN, a MAN, a WAN, a mobile, a wired or wireless network, a private network, or a virtual private network. While only three clients 115 are illustrated in FIG. 1 to simplify and clarify the description, it is understood that any number of client computers are supported and can be in communication with the server 105.

Both the server 105 and the clients 115 are computers that may include a CPU 130 (only shown in the clients), one or more computer readable memories 132, one or more user interfaces 134 (keyboard, touch screen, etc.), a network interface 136, one or more peripheral interfaces, and other well known components. As is known to one skilled in the art, other types of computers can be used that have different architectures. The client devices 115 represent any suitable handheld and/or mobile device, such as a mobile phone, personal data assistant, laptop computer, tablet personal computer, car navigation system, hand-held GPS unit, or “smart” device. More broadly, the client devices 115 represent any personal computing device, database, server, or network of such devices, or any other processing device having a user interface and CPU and capable of displaying a visual rendition of map data accessed from the map database 103 or other remote source of map data. Furthermore, while in some examples, the network 125 is described as a wireless network, the network 125 may be any wired or wireless network, where the clients 115 are devices on the network.

The server 105 and the clients 115 are also adapted to execute computer program modules for providing functionality described herein. As used herein, the terms “module” and “routine” refer to computer program logic used to provide the specified functionality. Thus, a module or a routine can be implemented in hardware, firmware, and/or software. In one embodiment, program modules and routines are stored on a storage device, loaded into memory, and executed by a processor or can be provided from computer program products that are stored in tangible computer-readable storage mediums (e.g., RAM, hard disk, optical/magnetic media, etc.).

The map database 103, which may be stored in or may be separate from the server 105, contains map data that can be used to generate a digital map or that can be used by, for example, a navigation system to determine routes between two locations. Physical roads, waterways, parks, landmarks, and other geographic elements may be represented in the map data by a list of nodes and segments that connect those nodes. Each node corresponds to a specific geographic location in the physical world. The data representation for each node generally includes a set of coordinates (e.g., latitude and longitude) and an association with one or more segments. For roads, each segment corresponds to a section of a physical location that begins at one node and ends at a different node. The data representation for each road segment, for example, can include a length and a number of attributes, such as a street name, a priority (e.g., a highway or a local road), speed information, a surface type, a road width, an indication of whether the road segment is a one-way segment, address ranges, usage (e.g., ramp or trail), etc.

The map data stored in the map database 103 can be obtained from several different sources such as the New York City Open Accessible Space Information System (OASIS) and the U.S. Census Bureau Topologically Integrated Geographic Encoding and Referencing system (TIGER). The map data can also be accessed by one of the map generators 120, modified, and stored back into the database 103. Further, the database 103 does not need to be physically located within server 105. For example, the database 103 can be partially stored within a client 115, can be stored in external storage attached to the server 105, or can be stored in a network attached storage. Additionally, there may be multiple servers 105 that connect to a single database 103. Likewise, the map database 103 may be stored in multiple different or separate physical data storage devices.

Each client 115 executes one of the map generators 120, each of which requests and receives pre-fetch map data from the server 105 and generates a visual display of the received map data that is presented to the user on a display of the interface 134. The map generator 120 is able to adjust that visual display in response to user interactions with the interface 134, for example, adjusting which map data is visualized at any given time in response to a user selecting to scroll (left, right, up, down, etc.) through the visual display, or in response to the user selecting to change the zoom level (e.g., scale) of the displayed map data.

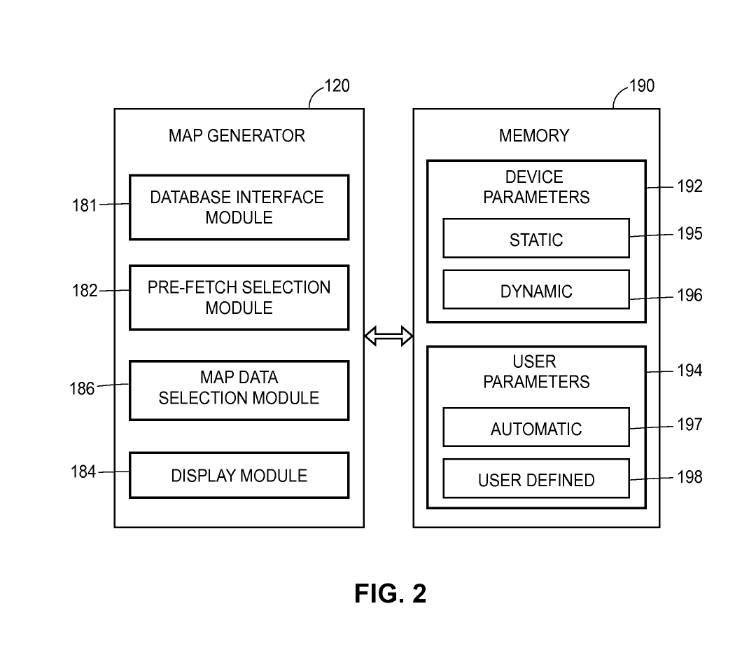

As illustrated in the detailed example of FIG. 2, the client 115 may include various modules within or associated with the map generator 120, including a database interface module 181 that operates to retrieve map data from the server 105 and map database 103. The map generator 120 further includes a pre-fetch selection module 182 that may be used to set a pre-fetch map data policy as discussed herein. The selection module 182 may identify one or more points of interest that are to be used by a display module 184 to create a visual map display of received map data on the interface 134. The points of interest determined by the module 182 are communicated by the interface module 181 through the network interface 136 through network 125 to the server 105, which responds by sending pre-fetch map data from the map database 103 back to the client device 115, where this pre-fetch map data is received by the database interface module 181 and is stored in a map buffer memory 180 of the client 115.

A map data selection module 186 accesses the stored pre-fetch map data and determines which portion of that buffered map data is to be provided to the display module 184 for creating the visual map display on the interface 134. The module 186, therefore, is responsive (after pre-fetching) to user interaction with the interface 134 to determine which portion of the pre-fetched map data should be displayed to the desires in response to a subsequent user interaction, which is determined by a centralized map position, user scrolling, and zoom level, for example.

In some embodiments, the pre-fetch selection module 182 identifies one or more zoom levels in the pre-fetch map data policy, which one or more zoom levels are communicated to the remote server 105 for identifying pre-fetch map data. The interface module 181 receives the pre-fetch map data from the server 105 and stores it in the buffer memory 180 for eventual display using the map data selector module 186 and the display module 184.

To set the pre-fetch map data policy, the selection module 182 accesses selection parameters stored in a memory 190, which may be portion of the memory 132. Generally speaking, the memory 190 contains any number of any suitable kind of selection parameters storing values accessed by the selection module 182. In the illustrated embodiment, the memory 190 includes two types of parameters, device parameters 192 and user parameters 194. In the illustrated example, the device parameters memory block 192 contains static device parameters 195 and dynamic device parameters 196, while the user parameters memory block 194 contains two sets of parameters. Automatically determined parameters 197 represent those user parameters compiled by the client device without express user control, for example, by the client device executing routines or modules to automatically track, monitor, and evaluate user-specific interactions. User determined parameters 198 are those set explicitly by the user, for example in response to a menu section, setup of the client device, or other techniques.

The pre-fetching selection module 182 will be discussed in further detail below. It is noted here, however, that the selection module 182 may include modules designed to further define pre-fetch map data.

Of course, some embodiments of the map generator 120 may have different and/or other modules than the ones described herein. Similarly, the functions described herein can be distributed among the modules in accordance with other embodiments in a different manner than that described herein.

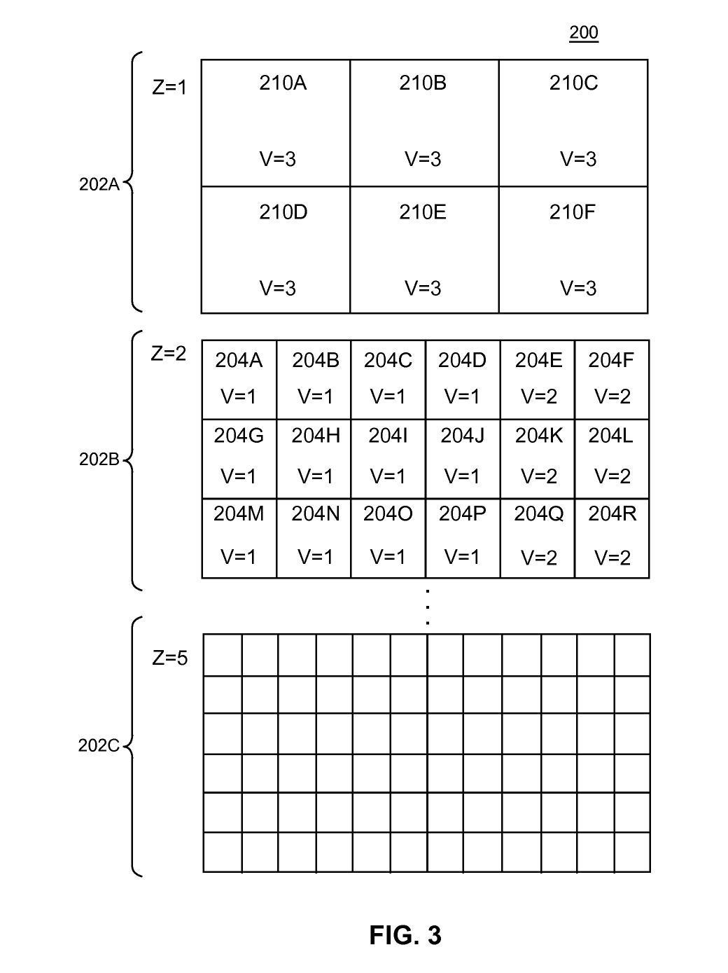

Generally speaking, in some embodiments, map data in the map database 103 is stored in different zoom levels each formed of a plurality of map data blocks, termed map tiles, which are used to construct a visual display of the map. FIG. 3 illustrates an example data structure 200 of a portion of the map database 103. The map data is stored in numerous (n) different zoom level data structures (only three of which are shown) 202A, 202B, and 202C, where each data structure is formed by a plurality of map data tiles. The data structure 202B, shows the map data at zoom level, z=2, is formed of 18 map data tiles, 204A-204R. The map tiles represent the basic building blocks for constructing a map display. Each map tile contains necessary map data to construct a portion of the map display, including data identifying roads, buildings, and geographic boundaries, such as water lines, county lines, city boundaries, state lines, mountains, parks, etc. The map data may be stored in any number of different zoom level data structures. In an embodiment, 19 total zoom levels (z=19) are provided.

The number of tiles at each zoom level increases, e.g., linearly, quadratically, exponentially, or otherwise. The zoom levels in the illustrated example (z=1, 2, and 5) have 6, 18, and 60 map data tiles, respectively, covering the same geographic area or region. While the data structure 200 is discussed in terms of the map database 103, it will be appreciated that, in some examples, a like data structure is used to store map data tiles on the client device 115.

In some embodiments, each map tile contains map data stored in a bitmap format, for display to the user using a raster display engine executed by the display module 184. In other embodiments, the map tile may contain map data stored in vector format, for display using a vector buildup display engine executed by the display module 184. In either case, the display module 184 may employ a C++, HTML, XML, JAVA, or Visual Basic application for generating a visual display of the map tiles.

In the illustrated embodiment of FIG. 3, all map data is stored in map tiles, and each map tile in a zoom level data structure is allocated the same memory allocation size. For example, each tile 204A-204R may be a bitmap image 10 Kbytes in size. This may be achieved, for example, by having each map tile cover the same sized geographic area. For map tiles containing vector data, the data size for each tile may vary, but each tile may still, in some embodiments, be allotted the same maximum memory space. Although not illustrated, in other embodiments, the data tiles will have different memory space allocations within a zoom level data structure.

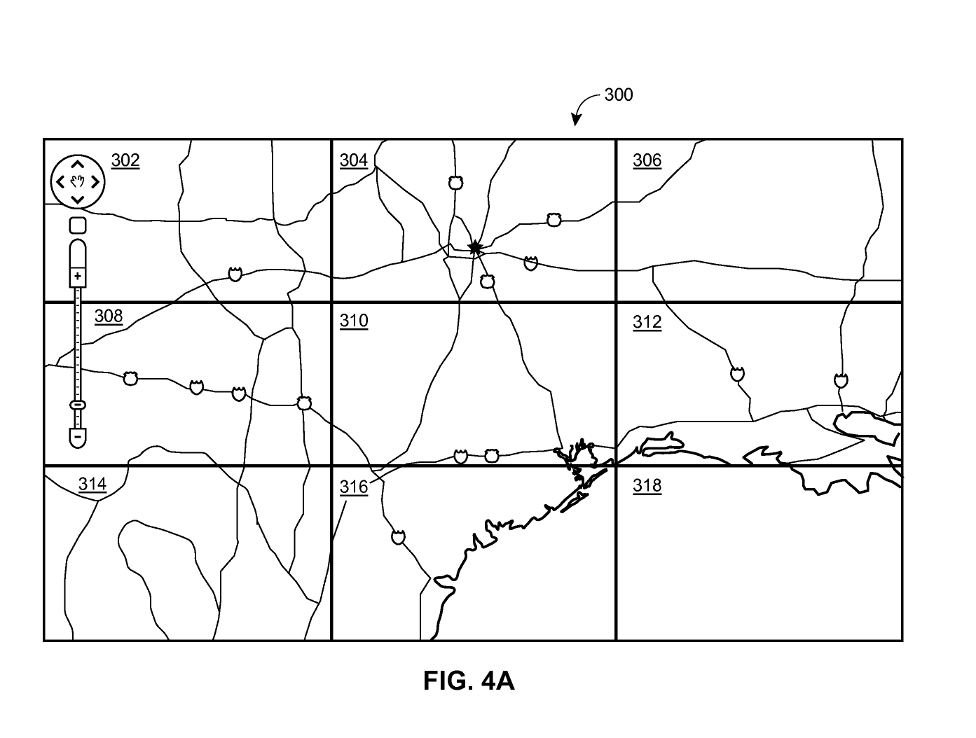

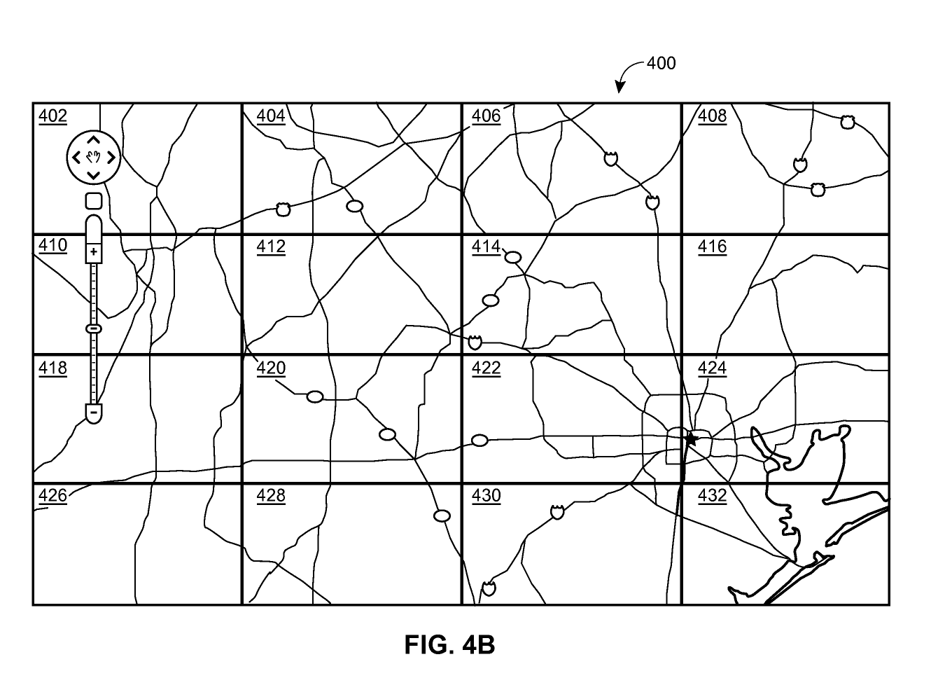

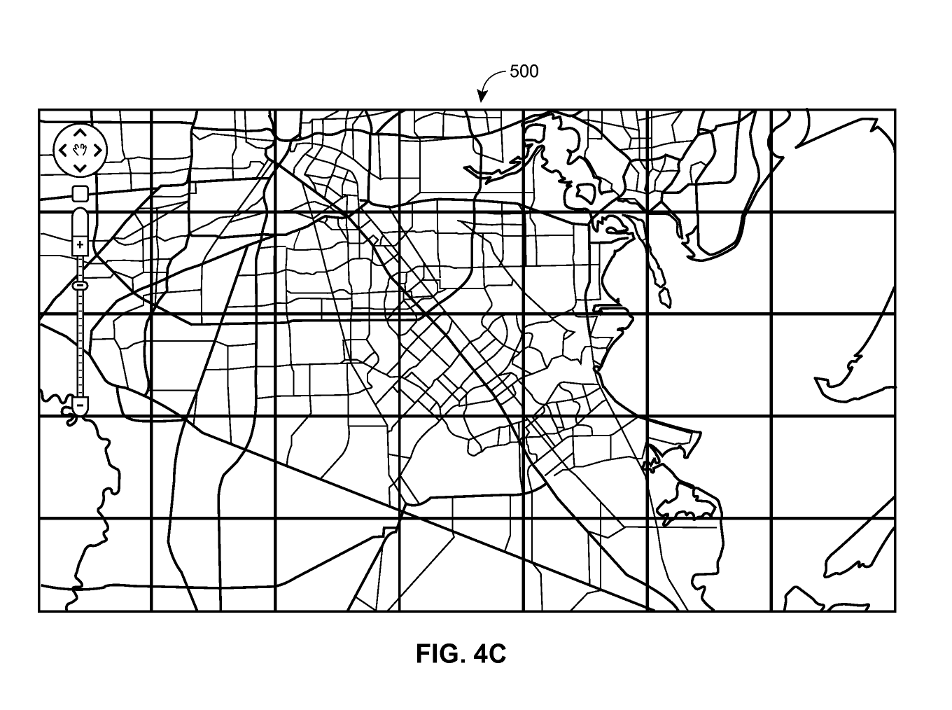

FIGS. 4A-4C illustrate visual map displays, e.g., that may be fully or partially displayed on the user interface 134, where each figure provides a visual display at a different zoom level. In the illustrated embodiments, FIG. 4A provides a visual map display 300 at an example zoom level, z=3, constructed of a series of map tiles 302-318, which cover the same size geographic area and which have the same amount of memory size.

In operation, the server 105 is able to transmit map data to respective clients 115 in chunks of data defined by these map tiles. For example, to transmit the map data needed to construct the map display 300, the server 105 may transmit each map tile in a frame, having a header portion providing identification data of the frame (such as geographic position, client device address, map tile version number, etc.) and a payload portion containing the specific map tile data to be used in forming the visual display. Although the map data may be stored and transmitted in other formats, map data tiles provide an effective mechanism for quantizing map data stored in the map database 103 and for quantizing communication of the map data over the network 125 to the clients 115.

In comparison to FIG. 4A, FIG. 4B illustrates a visual map display 400 at a zoom level higher than the zoom level of FIG. 4A, in this example zoom level, z=9. The map display 400 is formed of a plurality of map tiles 402-432 Like the map tiles 302-318, the map tiles 402-432 are each the same in size, e.g., covering the same geographic area and having the same memory size. FIG. 4C illustrates another visual map display 500 at a third even higher zoom level, zoom level z=11, formed of map data tiles.

Each of the displays 300, 400, and 500 is of a portion of the overall map data, which comprises many more map data tiles.

As illustrated across FIGS. 4A-4C, the map tiles that form each visual map display have various levels of detail. The tiles 302-318 illustrate geographic boundaries, but no roads, only highways and/or interstates, while the tiles of FIG. 4C are at a higher zoom level and contain information on roads, buildings, parks, end points, etc.

As the zoom levels increase, i.e., as the visual map display focuses down on a smaller geographic region, the amount of map data may reach a maximum point, beyond which all zoom levels will contain the same map data. The number of map tiles needed to construct a map display may vary but the total amount of map data becomes saturated. The zoom level corresponding to this point is termed the saturation zoom level and represents the zoom level at which all roads, building, parks, end points, and other map data elements for a geographic region are provided. Any additional zoom levels selected by the user merely zoom in further on these map data elements; but no additional map data elements are stored, or displayed. In the illustrated example of FIGS. 4A-4C, zoom level, z=11, represents the saturation zoom level.

While a user interacts with the visual map displays 300, 400, and 500, the user may wish to scroll around to display other map data near the illustrated map data. Therefore, the client device 115 uses a system to fetch and store a sufficient amount of map data to form the visual map display while buffering additional map data at the local device 115 to allow efficient user interaction with that display.

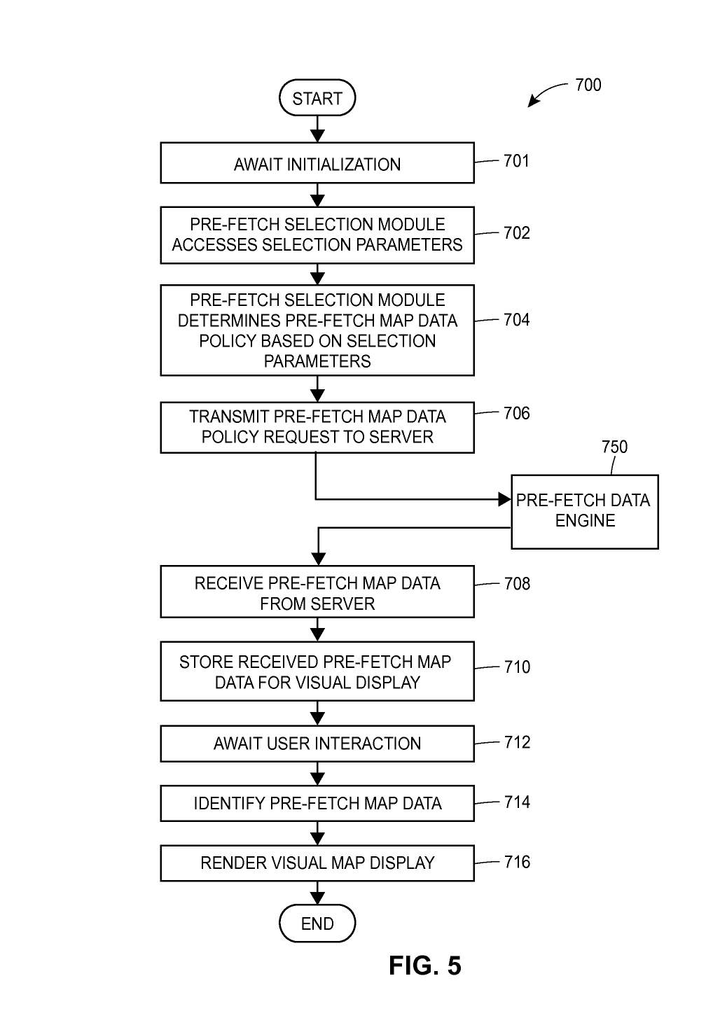

FIG. 5 illustrates a routine or process 700 for requesting and receiving map data tiles from a remote server. At a block 701, the routine or process 700 awaits initiation, which may result from user action, such as a user activating a mapping application on the client device 115. In some embodiments, the block 701 functions to automatically initiate the routine or process 700, for example, by periodically initiating pre-fetching map data. For example, the block 701 may be designed to initiate the process every hour, every day, a few times a day, or at any other suitable periodic interval. In some embodiments, that automatic initiation can occur in response to an event unbeknownst to the user of the client device, such as when mobile wireless services are initially activated on the client device or when the client device enters entirely new geographic region, such as when a user has traveled to a city location.

At a block 702, the pre-fetch selection module 182 accesses the memory 190 to automatically (i.e., without user interaction) identify one or more selection parameters for the device, including device characters and/or use parameters. In some embodiments, the block 702 is preset to examine only a select subset of the stored selection parameters, for example, where the module 182 has instructions to examine only specified selection parameters. In other embodiments, during execution of the routine or process 700, the block 702 may determine which selection parameters to access. For example, the block 702 may access the memory 190 to determine which selection parameters have been most recently updated, which selection parameters were last used in determining pre-fetch map data, or which selection parameters have the largest determined assurance factor indicating the likelihood the selection characteristic will capture the most desired pre-fetch map data for the device or user. Any of this data may be stored in a table in the memory 190 for example. Or this data may be determined by the pre-fetch selection module 182 at the block 702 from the stored parameters in memories 192 and 194.

At a block 704, the pre-fetch selection module 182 analyzes the one or more selection parameters from the block 702 and determines a pre-fetch map data policy. That pre-fetch map data policy identifies one or more pre-fetch map data requests. The pre-fetch map data policy may include one or more map points of interest or map categories of interest. In some embodiments, the selection module 182 determines the points of interest or categories of interest by analyzing user parameters 194, whether automatically determined (memory 197) or manually entered (memory 198). The selection module 182 may analyze stored user parameters 194, such as points of interest, such as favorite restaurants, hotels, neighborhoods, cities, museums, etc. Other user parameters 194 include hobbies of interest, such as hiking, skiing, sunbathing, cycling, mountain climbing. Yet, other user parameters 194 include types previous points of interest visited by the user, or more specifically by the user's device. Any of this user data may have been automatically collected and stored in the memory 197; while in other examples this data may have been previously entered by a user and stored in the memory 198.

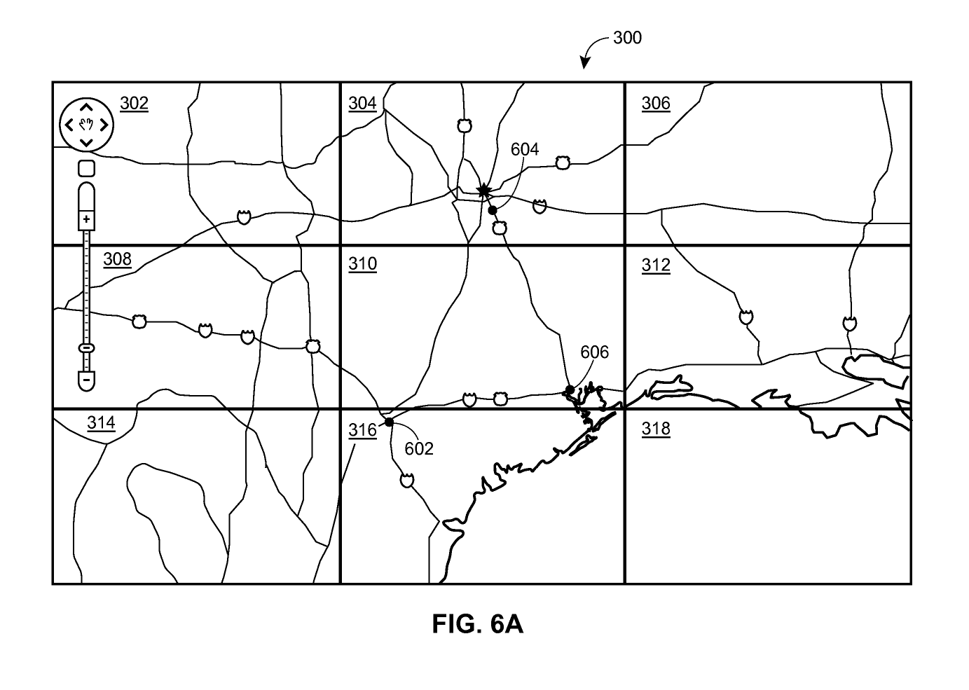

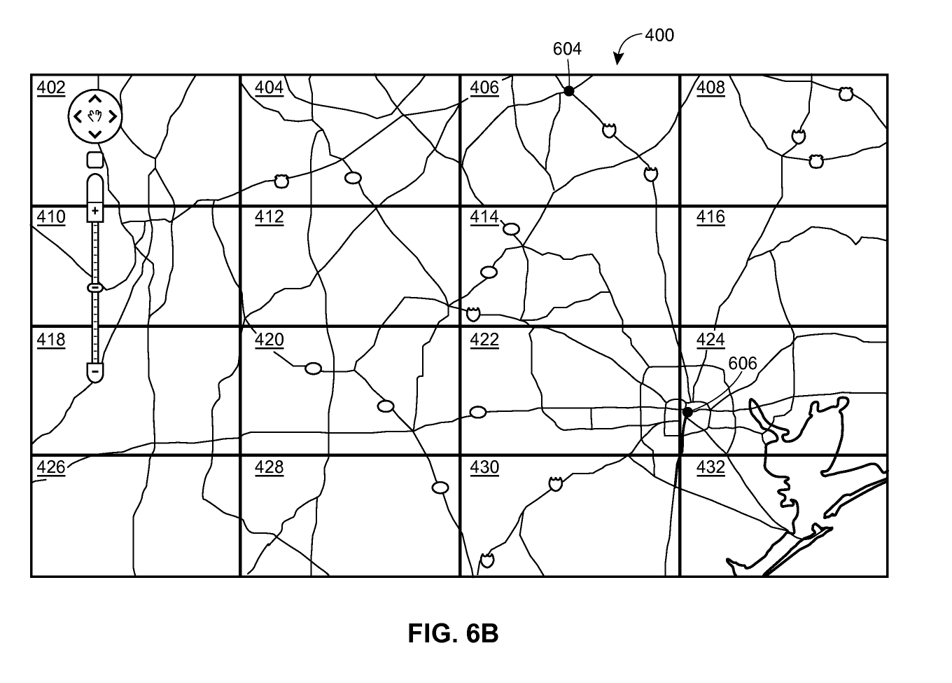

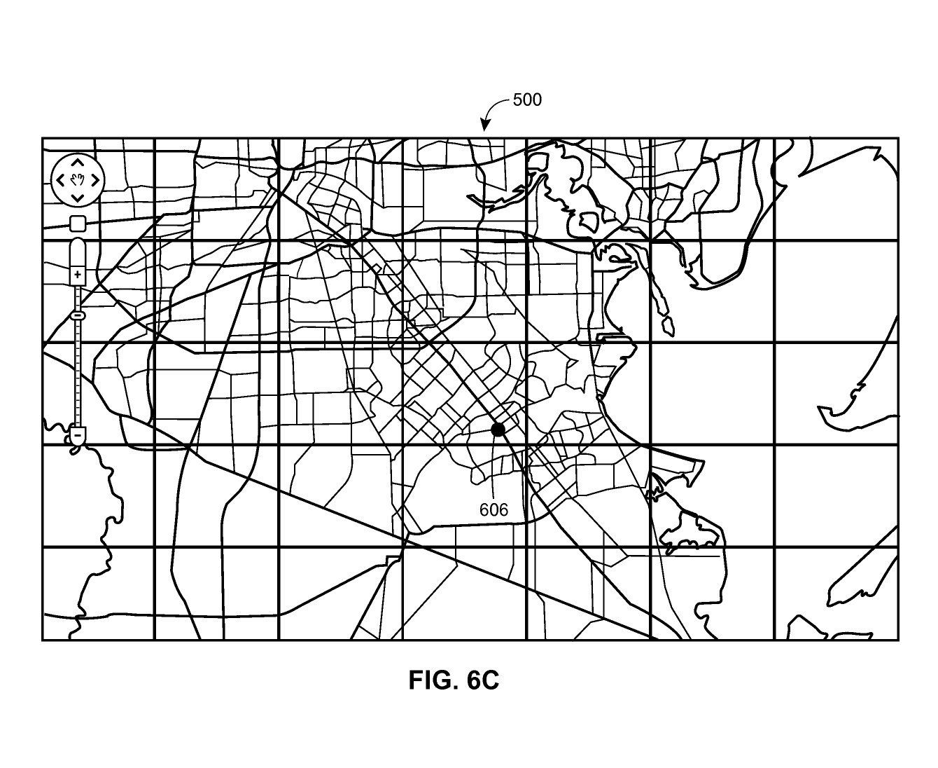

FIGS. 6A-6C illustrate the visual map displays (300, 400, and 500) of FIGS. 4A-4C, respectively, but showing map points of interest identified by the module 182. The points of interest that are displayed on the user interface 134 depending on the zoom level. FIG. 6A illustrates three points of interest 602, 604, and 606; while FIG. 6B illustrates only two points of interest 604 and 606; and FIG. 6C illustrates only one point of interest 606.

The pre-fetch map data policy, in other embodiments, includes zoom level data identifying one or more zoom levels at which map data is to be pre-fetched by the client device 115. In some examples, the zoom level forming the pre-fetch map data policy is identified in response an examination of the user parameters 194, such as points of interest, hobbies of interest, past usage data, etc.

At a block 706, the pre-fetch map data policy from block 704 is converted to a pre-fetch request that is sent to the remote server 105 by the database interface module 181. In an example, the pre-fetch request is sent in the form of a data frame containing

In the illustrated embodiment, at a block 706, the interface module 181 requests pre-fetch map data for all map points of interest, which the module may do all at one time or which the module may do one at a time. Either way, the interface module 181 may package the map policy data from the block 704 and send to the server as a data frame having an identification header that contains, among other things, an identification field identifying the client device and a payload that identifies the one or more request instructions forming the map policy, e.g., map points of interest, zoom levels, the span, i.e., how much area in latitude and longitude that the policy should cover, and the tile type, as indicated by map type, satellite type, and/or terrain type. The map points of interest may be identified by a longitude and latitude coordinate, in some embodiments. Optionally, in some embodiments the block 706 sends the entire pre-fetch map data policy to the server 105, in other examples, the block 706 may send the server 105 portions of the map policy and await a received “acknowledgement” signal from the server 105 before sending further portions of the map policy. An “acknowledgement” signal is also used, in some embodiments, by the block 706 confirming to the server 105 upon receipt of each subset of the of the pre-fetch map data received from the remote database 103.

In any event, in response to the map data policy, the pre-fetch engine 750 analyzes the map data policy and determines which map data is responsive to that map data policy and sends that identified pre-fetch map data back to the client device. At a block 708, the interface module 181 receives the identified pre-fetch map data from the server and, optionally, in some embodiments, performs error checking, map data version checking, and map data budget checking. In some examples, country specific or region specific rules for pre-fetching may be applied as well. The pre-fetch map data received at block 708 is then stored at a block 710.

The routine or process 700 passes control to a block 712, where the client device 115 awaits some user interaction, i.e., a subsequent interaction after the pre-fetching of blocks 701-710. Once as user as performed an interaction that is to result in rendering (i.e., construction and display) of a visual map display, through a block 714, the module 186 identifies a subset of the previously-stored pre-fetch map data to display to the user on a visual display that is rendered by the display module 184 through a block 716.

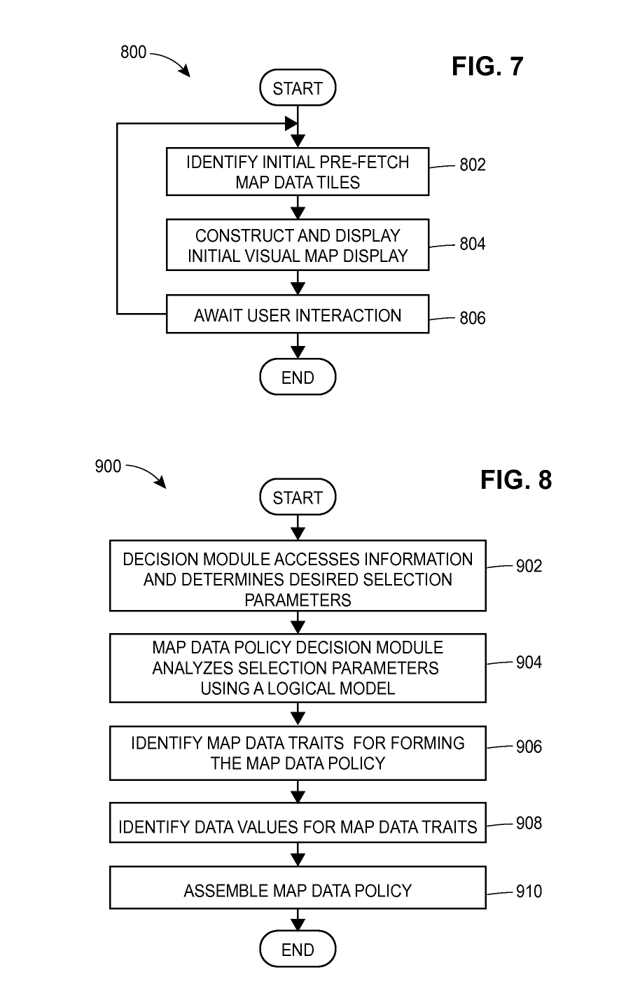

FIG. 7 illustrates a routine or process 800 that may be performed by the blocks 712-716, i.e., in response to a user request for map data occurring after the pre-fetch map data has been automatically collected and stored. The client device 115 maintains all received pre-fetch map data from the server 105 in the memory buffer 180. At a block 802, the map data selector module 186 identifies an initial subset of the pre-fetch map data for display. At a block 804, the display module 184 constructs and displays on the user interface 134 a visual map display of this initial subset of the pre-fetch map data, including one or more map points of interest. The initial display is provided to visualize the map points of interest, if identified in the pre-fetch map data policy determined at the block 704, and/or to visualize the map data at a predetermined zoom level, if identified in that pre-fetch map data policy.

The display is an initial display in that the client device will have likely received and stored an amount of map data much larger than that can be displayed at any given time, at a given zoom level. For example, if the map data is stored and received in the form of map data tiles, then the visual display will initially comprise a subset of these stored pre-fetch map data tiles. At a block 806, the display module 184 detects further user interactions with the interface 134, waiting for the user to interact with the visual display of map data as the user selects different regions of the map data that are to be displayed. For example, at the block 806, the display module 184 detects a user scrolling across the displayed map data to depict adjacent map data to the initial point of interest. Such scrolling may be sideways across the display, up or down, or any other desired direction. The user may also choose to alter the map by changing zoom levels, either increasing to zoom in further on the map data or decreasing to zoom further out. Further still, the user may use a tilting and/or rotating gesture of the device as a manipulation. The block 806 identifies map manipulation user interaction data to the block 802, which then determines which other pre-fetched map data, stored in the buffer memory 180, is to be displayed in response to the user interaction. Such other pre-fetch map data may be map data at the currently displayed zoom level or at a different zoom level. Or the block 806, upon appropriate instruction from the user, terminates the routine or process 800 entirely, for example, when a user selects to exit a mapping application.

FIG. 8 illustrates a routine or process 900 for automatically (i.e., without user interaction) developing pre-fetch map data policies as may be used by the blocks 702 and 704. At a block 902, the pre-fetch selection module 182 executes a decision module to determine which selection parameters are to be examined in determining a pre-fetch map data policy. In the illustrated example, at the block 902, the selection module 182 uses its decision module to access a selection characteristic instruction stored on the memory 190. The selection characteristic instruction identifies the one or more selection parameters that are to be used by selection module 182 to determine map data policy. In some examples, the instruction is a flag bit stored for each selection characteristic in a data table in memory 190, where a “1” indicates that the corresponding selection characteristic is to be used and a “0” indicates the corresponding selection characteristic is to be ignored. The data table may span the device characteristic memory 192 and the user characteristic memory 194, for example. In other example, a multiple bit instruction word is stored for each selection characteristic and indicates a weighted state for the corresponding selection characteristic, which allows the pre-fetch selection module 182 to use the selection parameters in weighted manner.

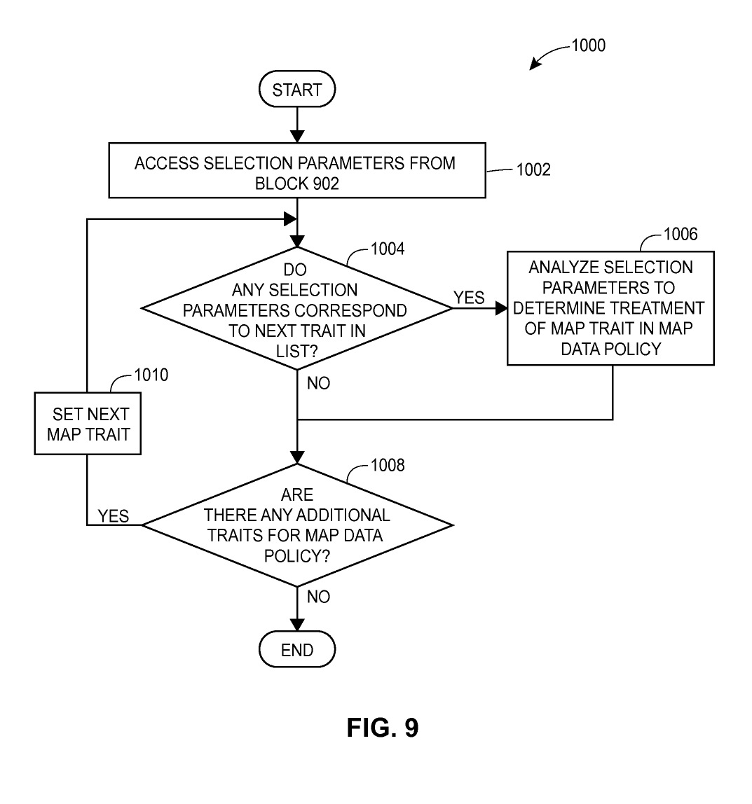

At a block 904, the pre-fetch selection module 182 takes the selection parameters identified by the decision module of block 902 and provides them to a policy decision module that analyzes the selection parameters. In some examples, the policy decision module of the selection module 182 applies decisional logic to manage the selection parameters. In some examples, the block 904 accesses a truth table providing map data policy instructions for given selection parameters or combinations of identified selection parameters. FIG. 9, discussed further below, illustrates an example implementation of the block 904. In some examples, the block 904 applies fuzzy decisional logic to determine a map data policy in response to the identified selection parameters.

At a block 906, the pre-fetch selection module 182 identifies a first map data policy trait based on the decisional logic applied at the block 904. Traits are the various types of data values that will collectively form the map data policy. For example, traits include map points of interest, zoom levels, and types of map data to be display. As the block 904 analyzes the selection parameters, the block 906 determines the types of traits that are to comprise the map data policy.

A block 908 then determines the values for each of the traits, e.g., the number and geographic location of map points of interest corresponding to the selection parameters. Another example includes the number of zoom levels, identified by zoom level number, that correspond to the selection parameters. Another example is specific types of map data that corresponds to the selection parameters. For example, if user parameters 194, those either automatically stored 197 or user stored 198, indicate hobbies or particular interests of a user of the client device, then the block 908 may identify those hobbies and particular interests for identifying geographic data corresponding to them. In some examples, the block 908 identifies a field code or some other indicator that is similarly used by the remote server 105 in identifying particular map data. For example, map data such as parks may be coded has having hiking trails and biking trails, such that a field code indicating a user interest in hiking or cycling, with identify such parks in the map data policy. Any number of field codes may be used, including those identifying map data associated with hiking, cycling, climbing, skiing, amusement parks, beaches, sailing, historical sights, etc.

At a block 910, the pre-fetch selection module 182 assembles the map data policy from the identified traits and the identified trait values.

While the routine or process 900 is described as performed by the client device in response to selection parameters stored on the client device, in other examples some or all of the steps may be performed at the remote server 105. For example, the selection characteristic data may be transmitted to the remote server 105 in a pre-processed form; and the server 105 may determine the responsive pre-fetch map data based on policies and decisional logic stored at or developed at the remote server 105.

FIG. 9 illustrates a routine or process 1000 that may be executed by the pre-fetch selection module 182 as the block 904. At a block 1002, the selection module 182 assesses the selection parameters from block 902 to determine the types of selection parameters, e.g., the device parameters 192 or the user parameters 194. At a block 1004, the routine or process determines if there are selection parameters that correspond to a first map data trait, e.g., map points of interest, zoom levels, map data type, etc. If one or more selection parameters correspond to the first map data trait, a block 1006 analyzes all selection parameters corresponding to the first map data trait to confirm that the first map data trait is to be included in the map data policy. The block 1006 then determines how that first map data trait is to be handled in the map data policy, for example, if the first trait is to always be used in identifying pre-fetch map data or if the first trait is to have a priority setting that may be used to weight the first trait over other traits with the pre-fetch map data policy, for example, where there may be conflicting map data corresponding to different traits. In this way, the block 1006 sets the first trait for provision to the block 908 and eventual inclusion in the map data policy of the block 910.

The block 1006 passes control to a block 1008, which also receives control if none of the selection parameters correspond to the first trait. At the block 1008, the pre-section module 182 determines if there is another potential trait for inclusion, where if so, a block 1010 sets the next trait and passes control back to block 1006, and where if not, the routine or process 1000 ends. If control is returned to the block 1006, then the steps above repeat for the second trait and until all possible traits are identified for inclusion in the map data policy.

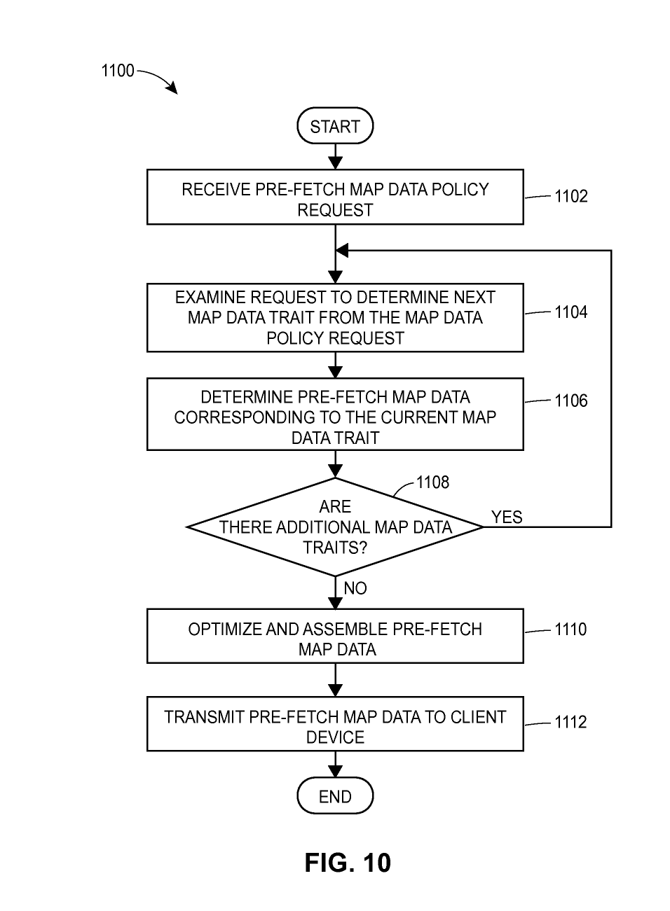

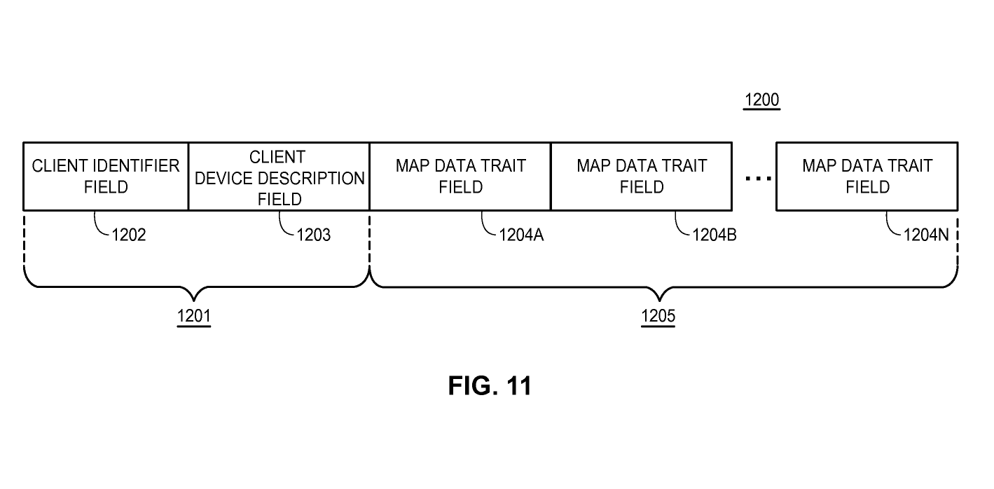

FIG. 10 illustrates an example routine or process 1100 as may be performed by the server 105 in response to receiving the pre-fetch map data policy request from block 706 of FIG. 5, where the routine or process 1100 is performed by the pre-fetch data engine 750. At a block 1102, the server 105 receives the request instructions from the client device 115, after which a block 1104 examines the requests to identify traits within the request. An example map data policy request frame 1200, from a client device, is shown in FIG. 11 and includes a header portion 1201 having a client identifier field 1202 for identifying the client device for downstream communications and client device descriptor field 1203 that may contain data on the type of device, carrier, etc. A payload portion 1205 of the frame 1200 comprises a plurality of map data trait fields of which 1204A-1204N are shown, where N is an integer. Each of the trait fields is assigned a particular trait that will be recognizable to the pre-fetch engine 750 for accessing particular map data from the database 103.

At a block 1106, the pre-fetch engine 750 analyzes the data for the first trait, stored in 1204A, and determines which map data in the map database 103 is responsive thereto, for assembling into pre-fetch map data. For example, the block 1106 may identify map data corresponding to an identified point of interest, map data of a particular type (e.g., map data identifying hiking trails, cycling paths, etc.), map data at particular zoom levels, etc., depending on the trait of the first field 1204A. This routine or process contains so long as block 1108 identifies additional map data trains 1204B-1204N, until all traits have been addressed.

Optionally, at a block 1110, the pre-fetch engine 750 takes all of the pre-fetch map data identified by the repeated steps of block 1106 and performs an optimization on the data. For example, the block 1110 may determine if there is any in conflicting pre-fetch map data, which the block 1110 will attempt to resolve. More commonly, however, the block 1110 will look to optimize the identified pre-fetch map data by compressing the data to reduce its overall size. For example, if the pre-fetch map data identified in response to one map data trait overlaps with other pre-fetch map data, the block 1110 will attempt to combine the overlapping data to form an optimized pre-fetch map data.

At a block 1112, the server transmits the pre-fetch map data from the block 1110 to the client device for storage and partial or full display to the user.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 125 may include but is not limited to any combination of a LAN, a MAN, a WAN, a mobile, a wired or wireless network, a private network, or a virtual private network. Moreover, while only three clients 115 are illustrated in FIG. 1 to simplify and clarify the description, it is understood that any number of client computers are supported and can be in communication with the server 105.

Additionally, certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a map editor system for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method comprising:
identifying, on a client device, one or more pre-fetch selection parameters, where the pre-fetch selection parameters include at least one of device parameters associated with the client device and user parameters;
determining, on the client device, from the one or more identified pre-fetch selection parameters, a pre-fetch map data policy;
requesting, from a remote map database storing the map data, pre-fetch map data stored in the remote map database and corresponding to the pre-fetch map data policy determined on the client device, wherein the pre-fetch map data is to be stored on the client device for eventual rendering of a visual display of map data in response to a subsequent user request;
receiving, at the client device, the pre-fetch map data from the remote database and corresponding to the pre-fetch map data policy; and
storing the received pre-fetch map data in a local memory on the client device until the subsequent user request.

2. The method of claim 1, wherein identifying one or more pre-fetch selection parameters comprises accessing a memory on the client device, the memory storing the device parameters as the pre-fetch selection parameters, and wherein determining the pre-fetch map data policy comprises comparing the device parameters to a predetermined set of map data policy rules to determine the pre-fetch map data policy for the values of the device parameters.

3. The method of claim 2, wherein the device parameters are selected from the group consisting of a hardware platform identifier for the client device, a version identifier for the client device, a language setup on the client device, and a location of the client device.

4. The method of claim 1, wherein the pre-fetch map data policy identifies zoom levels for the requested pre-fetch map data, wherein the map data stored on the remote map database is stored in a plurality of zoom levels, each containing map data for creating a visual map display at a different visual zoom level.

5. The method of claim 4, wherein the map data is stored in the map database in a plurality of map data tiles at each of the zoom levels, and wherein the pre-fetch map data policy identifies a subset of the map data tiles at at least one zoom level as the pre-fetch map data requested.

6. The method of claim 1, wherein pre-fetch map data policy identifies a subset of the map data in the map database such that the requested pre-fetch map data is a subset of the map data in the map database.

7. The method of claim 6, wherein the map data is stored in the map database in a plurality of map data tiles, and wherein the pre-fetch map data policy identifies a subset of the map data tiles as the pre-fetch map data requested.

8. The method of claim 1, wherein pre-fetch map data policy identifies points of interest within the map data in the map database such that the requested pre-fetch map data contains a subset of the map data in the map database that corresponds to the points of interest.

9. The method of claim 8, wherein the map data is stored in the map database in a plurality of map data tiles, and wherein the pre-fetch map data policy identifies a subset of the map data tiles corresponding to the points of interest as the pre-fetch map data requested.

10. The method of claim 1, wherein identifying the one or more pre-fetch selection parameters comprises, in response to a triggering event, automatically accessing a memory on the client device, the memory storing the at least one of the device parameters or the user parameters; and analyzing the pre-fetch selection parameters according to a set of predetermined rules.

11. The method of claim 10, wherein the triggering event is a time based event determined by the client device.

12. The method of claim 1, wherein identifying one or more pre-fetch selection parameters comprises accessing a memory on the client device, the memory storing the user parameters as the pre-fetch selection parameters, and wherein determining the pre-fetch map data policy comprises comparing the user parameters to a predetermined set of map data policy rules to determine the pre-fetch map data policy for the values of the device parameters.

13. The method of claim 12, wherein the user parameters are selected from the group consisting of a user interest, user usage patterns, and user account type.

14. The method of claim 12, wherein the user parameters are automatically stored usage parameters.

15. The method of claim 12, wherein the user parameters are usage parameters manually entered by a user.

16. A computer-readable medium storing instructions, the instructions when executed by a processor cause the processor to:
identify one or more pre-fetch selection parameters, where the pre-fetch selection parameters include at least one of device parameters associated with the client device and user parameters;
determine, from the one or more identified pre-fetch selection parameters, a pre-fetch map data policy;
request, from a remote map database storing map data, pre-fetch map data stored in the remote map database and corresponding to the pre-fetch map data policy determined on the client device, wherein the pre-fetch map data is to be stored on the client device for eventual rendering of a visual display of map data in response to a subsequent user request;
receive, at the client device, the pre-fetch map data from the remote database; and
store the received pre-fetch map data in a local memory on the client device until the subsequent user request.

17. The computer-readable medium storing instructions of claim 17, having further instructions that, when executed, cause the processor to:
access a memory on the client device, the memory storing the device parameters as the pre-fetch selection parameters; and
compare the device parameters to a predetermined set of map data policy rules to determine the pre-fetch map data policy for the values of the device parameters.

18. The computer-readable medium storing instructions of claim 17, wherein the device parameters are selected from the group consisting of a hardware platform identifier for the client device, a version identifier for the client device, a language setup on the client device, and a location of the client device.

19. The computer-readable medium storing instructions of claim 16, wherein the pre-fetch map data policy identifies zoom levels for the requested pre-fetch map data, wherein the map data stored on the remote map database is stored in a plurality of zoom levels, each containing map data for creating a visual map display at a different visual zoom level.

20. The computer-readable medium storing instructions of claim 19, wherein the map data is stored in the map database in a plurality of map data tiles at each of the zoom levels, and wherein the pre-fetch map data policy identifies a subset of the map data tiles at least one zoom level as the pre-fetch map data requested.

21. The computer-readable medium storing instructions of claim 16, wherein pre-fetch map data policy identifies points of interest within the map data in the map database such that the requested pre-fetch map data contains a subset of the map data in the map database that corresponds to the points of interest.

22. The computer-readable medium storing instructions of claim 21, wherein the map data is stored in the map database in a plurality of map data tiles, and wherein the pre-fetch map data policy identifies a subset of the map data tiles corresponding to the points of interest as the pre-fetch map data requested.

23. The computer-readable medium storing instructions of claim 16, having further instructions that, when executed, cause the processor to:
in response to a triggering event, automatically access a memory on the client device, the memory storing the at least one of the device parameters or the user parameters; and
analyze the pre-fetch selection parameters according to a set of predetermined rules.

24. The computer-readable medium storing instructions of claim 23, wherein the triggering event is a time based event determined by the client device.

25. The computer-readable medium storing instructions of claim 16, having further instructions that, when executed, cause the processor to:
access a memory on the client device, the memory storing the user parameters as the pre-fetch selection parameters; and
compare the user parameters to a predetermined set of map data policy rules to determine the pre-fetch map data policy for the values of the device parameters.

26. The computer-readable medium storing instructions of claim 25, wherein the user parameters are selected from the group consisting of a user interest, user usage patterns, and user account type.

27. The computer-readable medium storing instructions of claim 25, wherein the user parameters are automatically stored usage parameters.

28. The computer-readable medium storing instructions of claim 16, wherein the user parameters are usage parameters manually entered by a user.

29. A computer system for fetching map data to be used in rendering a visual display of map data on a client device, the computer system comprising:
a display module for rendering the visual display of the map data on the client device;
a pre-fetch selection module to analyze pre-fetch selection parameters for the client device to determine a pre-fetch map data policy for the client device, wherein the pre-fetch selection parameters include at least one of device parameters associated with the client device and user parameters; and
a database interface module to request, from a remote server having a map database, pre-fetch map data responsive to the pre-fetch map data policy, and to receive, from the remote server, the pre-fetch map data responsive to the pre-fetch map data policy, wherein the pre-fetch map data is to be stored on the client device for eventual rendering of a visual display of map data in response to a subsequent user request.

30. The computer system of claim 29, wherein pre-fetch selection module accesses a memory on the client device, the memory storing the device parameters as the pre-fetch selection parameters; and
analyzes the device parameters to determine the pre-fetch map data policy.

31. The computer system of claim 30, wherein the device parameters are selected from the group consisting of a hardware platform identifier for the client device, a version identifier for the client device, a language setup on the client device, and a location of the client device.

32. The computer system of claim 29, wherein the pre-fetch map data policy identifies zoom levels for the requested pre-fetch map data, wherein the map data stored on the remote map database is stored in a plurality of zoom levels, each containing map data for rendering the visual map display at a different visual zoom level.

33. The computer system of claim 32, wherein the map data is stored in the map database in a plurality of map data tiles at each of the zoom levels, and wherein the pre-fetch map data policy identifies a subset of the map data tiles at least one zoom level as the pre-fetch map data requested.

34. The computer system of claim 29, wherein pre-fetch map data policy identifies points of interest within the map data in the map database such that the requested pre-fetch map data contains a subset of the map data in the map database that corresponds to the points of interest.

35. The computer system of claim 34, wherein the map data is stored in the map database in a plurality of map data tiles, and wherein the pre-fetch map data policy identifies a subset of the map data tiles corresponding to the points of interest as the pre-fetch map data requested.

36. The computer system of claim 29, wherein the pre-fetch selection module
in response to a triggering event, automatically accesses a memory on the client device, the memory storing the at least one of the device parameters or the user parameters; and
analyzes the pre-fetch selection parameters according to a decisional logic to determine the pre-fetch map data policy.

37. The computer system of claim 36, wherein the triggering event is a time based event determined by the client device.

38. The computer system of claim 29, wherein the pre-fetch selection module:
accesses a memory on the client device, the memory storing the user parameters as the pre-fetch selection parameters; and
compares the user parameters to a predetermined set of map data policy rules to determine the pre-fetch map data policy for the values of the device parameters.

39. The computer system of claim 38, wherein the user parameters are selected from the group consisting of a user interest, user usage patterns, and user account type.

40. The computer system of claim 38, wherein the user parameters are automatically stored usage parameters.

41. The computer system of claim 38, wherein the user parameters are usage parameters manually entered by a user.

42. A computer-implemented method for downloading pre-fetch map data to a client device for use in rendering a visual display of map data on the client device, the method comprising:
receiving a pre-fetch map data policy request from the client device, where the pre-fetch map data policy request comprises one or more map data traits and wherein the pre-fetch map data policy request depends on device parameters or user parameters for the client device;
analyzing the one or map data traits in the pre-fetch map data policy request to determine pre-fetch map data corresponding to the device parameters or the user parameters for the client device, wherein the pre-fetch map data is to be stored on the client device for eventual rendering of a visual display of map data in response to a subsequent user request; and
transmitting the pre-fetch map data to the client device.

43. The method of claim 42, wherein the pre-fetch map data policy request comprises a plurality of different map data traits, the method further comprising:
analyzing each of the plurality of map data traits to determine the pre-fetch map data; and
optimizing the determined pre-fetch map data prior to transmission to the client device.

44. A computer-readable medium storing instructions, the instructions when executed by a processor cause the processor to:
receive a pre-fetch map data policy request from the client device, where the pre-fetch map data policy request comprises one or more map data traits and wherein the pre-fetch map data policy request depends on device parameters or user parameters for the client device;
analyze the one or map data traits in the pre-fetch map data policy request to determine pre-fetch map data corresponding to the device parameters or the user parameters for the client device, wherein the pre-fetch map data is to be stored on the client device for eventual rendering of a visual display of map data in response to a subsequent user request; and
transmit the pre-fetch map data to the client device.

45. The computer-readable medium storing instructions of claim 44, wherein the pre-fetch map data policy request comprises a plurality of different map data traits, and having further instructions that, when executed, cause the processor to:
analyze each of the plurality of map data traits to determine the pre-fetch map data; and
optimize the determined pre-fetch map data prior to transmission to the client device.

46. A server for downloading pre-fetch map data to a client device for use in rendering a visual display of map data on the client device, the server comprising:
a memory for storing a map database; and
a pre-fetch engine configured to,
receive a pre-fetch map data policy request from the client device, where the pre-fetch map data policy request comprises one or more map data traits and wherein the pre-fetch map data policy request depends on device parameters or user parameters for the client device,
analyze the one or map data traits in the pre-fetch map data policy request to identify from the map database pre-fetch map data corresponding to the device parameters or the user parameters for the client device, wherein the pre-fetch map data is to be stored on the client device for eventual rendering of the visual display of map data in response to a subsequent user request, and
transmit the pre-fetch map data to the client device.

47. The server of claim 46, wherein the pre-fetch engine is further configured to:
analyze each of the plurality of map data traits to determine the pre-fetch map data from the map database; and
optimize the determined pre-fetch map data prior to transmission to the client device.
